(19) United States
(12) Patent Application Publication
(10) Pub. No.: US 2004/0017822 A1
(43) Pub. Date: Jan. 29, 2004

(54) High-speed digital subscriber line (HDSL) wander reduction utilizing minimums

(75) Inventors: Harrison Doan, Huntington Beach, CA (US); Dung Quoc Nguyen, Irvine, CA (US); Ramya Niroshana Dissanayake, Tustin, CA (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/202,821

(22) Filed: Jul. 25, 2002

(51) Int. Cl. H04J 3/16

(52) U.S. Cl. 370/465

(57) ABSTRACT

An apparatus and method are described that allows for improved wander jitter reduction in communication devices and associated communication links, in particular on HDSL communication devices and links. The improved device apparatus and method detects the current data rate offset of the HDSL data rate being utilized and the data rate of the datastream being transmitted through the HDSL communication link and allows for the transmitting HDSL communication device to adjust the HDSL data rate to promote instantaneous data rate offsets that are close to wander jitter minimum points. The improved device apparatus and method also allows for the characterization of communication devices for their specific wander jitter low activity points by sweeping the input data rate being transmitted at differing HDSL data rates.

### TECHNICAL FIELD

The present invention relates generally to communication devices and in particular the present invention relates to wander reduction in high-speed digital subscriber line (HDSL) communication devices.

### BACKGROUND

Modern networks and network systems are typically constructed of multiple differing devices, elements, or links, referred to collectively herein as elements. These elements include communication devices that connect networks and other elements across a link. Links can be virtual links that connect through other communication devices or physical links that connect across physical wire, cables, wireless, or optical connections. Links can be of multiple protocols and physical connections and signaling methods. Telecommunication devices are specialized communication devices that connect networks and elements across links that are part of a telecommunications or phone system. Examples of such include, but are not limited to, digital subscriber line (DSL), ethernet links, modems, token ring, network hubs, network switches, wide area network (WAN) bridges, integrated services digital network (ISDN) devices, T1 termination units, etc. In particular, one recent such communications link and protocol is the high-speed digital subscriber line (HDSL), which has 2 wire and 4 wire variants (HDSL2 and HDSL4). The HDSL2 and HDSL4 protocols are defined in industry standards to provide for common conventions and interoperability between HDSL communication devices from differing manufacturers.

Many modern HDSL communication systems typically will encapsulate or transmit another, typically slower data or bit rate, communication protocol within the HDSL protocol and framing to transmit it across the HDSL communication link between the central office (CO) HDSL communication device and the customer premise equipment (CPE)/remote (RMT) HDSL communication device. Encapsulation of another protocol generally refers to the process of reception of a data signal, extraction of a datastream that contains a communication protocol, and the transmission of the datastream through the communication link for re-transmittal at the receiving communication device without the separation of the data and protocol contained in the received datastream. Data transmission through a communication link refers to the reception of a data signal where the underlying data is extracted and transmitted across the communication link without the original communication protocol. A new data signal is then created at the receiving communication device utilizing the transmitted data and the appropriate transmission protocols are inserted. Both encapsulation and data transmission are referred to herein as data transmission. One such commonly encapsulated or transmitted protocol is the T1/DS1 protocol (commonly referred to as T1), defined by American National Standards Institute (ANSI) T1.107 standard digital signal 1 (DS1) standard.

Many communication protocols allow the actual or instantaneous data rate to vary from their defined nominal data/bit rate depending on the data being transmitted at a given moment. For example, a T1 link has a nominal data rate of 1.5 mega-bits per second (Mbps) and can vary from that nominal data rate by +/−200 bits per second (bps). The HDSL2 and HDSL4 communication protocols are defined with variable data/frame rates allowing the HDSL communication devices to adjust their data/frame rates to better match the data rate of the communication protocol being transmitted through or encapsulated in the HDSL protocol. In encapsulation or transmission of the data of one communication protocol through another communication protocol, a common problem called “wander jitter” or “wander” occurs when there are mismatches between the data/frame rate of the communication link and the datastream being transmitted or encapsulated through the link. Wander is defined as a low frequency (<10 Hz) variance in the data clock/signal of the transmitted or encapsulated protocol after it has been transmitted through the HDSL communication link that occur because of the inefficient transmission or encapsulation by the HDSL communication device at a given HDSL data/frame rate and a given transmitted or encapsulated communication protocol's instantaneous data rate.

Wander jitter can put the transmitted or encapsulated communication protocol out of specification, causing signaling errors, when it is recreated or relayed out of the receiving HDSL communication device. For example, these data clock/signal variations will cause a T1 signal transmitted through an HDSL communication link to go out of specification when recreated at the receiving HDSL communication device and cause a transmission/protocol error.

For the reasons stated above, and for other reasons stated below which will become apparent to those skilled in the art upon reading and understanding the present specification, there is a need in the art for a method and apparatus for conveniently detecting wander jitter and adjusting for wander jitter in HDSL communication devices that transmit or encapsulate other communication protocols over an HDSL communication link.

### SUMMARY

The above-mentioned problems with detecting and adjusting for wander jitter in HDSL communication devices that transmit or encapsulate other communication protocols over an HDSL communication link are addressed by embodiments of the present invention and will be understood by reading and studying the following specification.

In one embodiment, a method of operating a High-speed Digital Subscriber Line (HDSL) communication device comprises sensing an offset between a data rate of a datastream and a selected HDSL datastream data rate, and selectively adjusting the HDSL datastream data rate to an optimal data rate to move the data rate offset closer to a low wander jitter minimum.

In another embodiment, a method of operating a High-speed Digital Subscriber Line (HDSL) communication system comprises sensing an offset between a data rate of a transmitted datastream and the data rate of an HDSL protocol datastream of an HDSL communication link, and selectively adjusting the HDSL protocol datastream data rate to an optimal data rate to move the data rate offset closer to a low wander jitter minimum.

In yet another embodiment, a method of operating a High-speed Digital Subscriber Line (HDSL) communication device comprises receiving a T1 datastream, incorporating the T1 datastream in an HDSL protocol datastream, transmitting the HDSL protocol datastream, sensing an offset between an instantaneous data rate of the T1 datastream and a data rate of the HDSL protocol datastream, and selectively adjusting the HDSL protocol datastream data rate to an optimal data rate to move the data rate offset closer to a wander jitter minimum point.

In a further embodiment, a machine-usable medium having machine-readable instructions stored thereon for execution by a processor of a communication device to perform a method. The method comprising receiving a T1 datastream, incorporating the T1 datastream in an HDSL protocol datastream, transmitting the HDSL protocol datastream, sensing an offset between an instantaneous data rate of the T1 datastream and a data rate of the HDSL protocol datastream, and selectively adjusting the HDSL protocol datastream data rate to an optimal data rate to reposition the data rate offset closer to a wander jitter minimum.

In yet a further embodiment, a high-speed digital subscriber line (HDSL) communication device comprises an HDSL interface coupled to an HDSL chipset, wherein the HDSL chipset is adapted to transceive an HDSL datastream with a selectively adjustable HDSL data rate through the HDSL interface, a data interface coupled to the HDSL chipset, wherein the data interface is adapted to transceive a datastream with a data rate, and wherein a data rate offset is measured between the datastream data rate and the HDSL data rate by the HDSL chipset and the HDSL data rate is selectively adjusted to an optimal data rate to move the data rate offset closer to a low wander jitter minimum.

In another embodiment, a high-speed digital subscriber line (HDSL) communication system comprises an HDSL communication link, and a plurality of HDSL communication devices coupled to the HDSL communication link, wherein a first HDSL communication device of the plurality of HDSL communication devices is a central office (CO) HDSL communication device and a second HDSL communication device of the plurality of HDSL communication devices is a remote (RMT) HDSL communication device, and wherein at least one of the plurality of HDSL communication devices comprises an HDSL interface coupled to an HDSL chipset, wherein the HDSL chipset is adapted to transceive an HDSL datastream with a selectively adjustable HDSL data rate through the HDSL interface to the HDSL communication link, a data interface coupled to the HDSL chipset, wherein the data interface is adapted to transceive a datastream with a data rate, wherein a data rate offset is measured between the datastream data rate and the HDSL data rate by the HDSL chipset, and wherein the HDSL data rate is selectively adjusted to an optimal data rate to reposition the data rate offset closer to a wander jitter minimum.

In yet another embodiment, a method of characterizing a High-speed Digital Subscriber Line (HDSL) communication device comprises selecting each HDSL data rate in turn of a plurality of HDSL data rates, sweeping an allowed data rate range for an input datastream for each selected HDSL data rate, and sensing and recording a wander jitter rate and wander jitter minimum points for the HDSL communication device for an instantaneous data rate of the input datastream at each selected HDSL data rate.

In a further embodiment, a high-speed digital subscriber line (HDSL) communication system comprises an HDSL communication link, and a central office (CO) HDSL communication device coupled to the HDSL communication link and a remote (RMT) HDSL communication device coupled to the HDSL communication link, wherein the CO HDSL communication device comprises an HDSL interface coupled to an HDSL chipset, wherein the HDSL chipset is adapted to transceive an HDSL datastream with a selectively adjustable HDSL data rate through the HDSL interface to the HDSL communication link, a T1 data interface coupled to the HDSL chipset, wherein the T1 data interface is adapted to transceive a T1 datastream with a data rate, wherein a data rate offset is measured between the T1 datastream data rate and the HDSL data rate by the HDSL chipset, and wherein the HDSL data rate is selectively adjusted to an optimal data rate to move the data rate offset closer to a low wander jitter minimum.

In yet a further embodiment, a method of wander reduction comprises sensing an offset between a data rate of a datastream and a selected High-speed Digital Subscriber Line (HDSL) datastream data rate, and selectively adjusting the HDSL datastream data rate to an optimal data rate to move the data rate offset closer to a low wander jitter minimum of an HDSL communication device.

Other embodiments are described and claimed.

### BRIEF DESCRIPTION OF THE DRAWINGS

FIG. 1 is a simplified flowchart of a communication system wander performance detection algorithm according to another embodiment of the present invention.

FIG. 2 is a simplified diagram of an HDSL communication system according to one embodiment of the present invention.

FIG. 3 is a simplified diagram of an HDSL communication device according to one embodiment of the present invention.

FIG. 4 is a simplified flowchart of a communication system wander reduction algorithm according to one embodiment of the present invention.

FIGS. 5A and 5B are simplified flowcharts of a communication system wander reduction algorithms utilizing EOC signaling according to another embodiment of the present invention.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

As stated above, wander jitter induced in a data stream transmitted or encapsulated through an HDSL link can cause transmission errors and protocol violations in the transmitted or encapsulated communication protocol when it is recreated at the receiving HDSL communication device. Such wander jitter caused by instantaneous data rate mismatches in the transmitted or encapsulated communication protocol data rate and the HDSL data rate can result in increased number of transmission errors, dropped data frames, lower transmission rates, and/or loss of service for the customer.

In embodiments of the present invention, when encapsulating or transmitting another protocol an HDSL communication device will typically fit the received data or protocol to be transmitted into an HDSL data frame for transmission across the HDSL communication link. Any remaining space in the HDSL data frame is “bit stuffed” with a known bit pattern (typically all 1's or 0's) to fill out the HDSL data frame. A “short” frame is an HDSL data frame that did not have any remaining space in frame after incorporation of the data to be transmitted and therefore does not need bit stuffing. A “long” frame is an HDSL data frame that was bit stuffed. The ratio of short to long HDSL data frames in a given time period gives an indication of the instantaneous data rate offset between the transmitted or encapsulated protocol and the HDSL data/frame rate being utilized for transmission. Many commercial HDSL chipsets will count the number of long or short HDSL data frames as part of their commonly kept statistics on the HDSL communication link they are coupled to.

Embodiments of the present invention utilize an improved apparatus and/or method to reduce wander jitter induced in the data clocks of communication protocols transmitted through HDSL communication devices and links by sensing the current instantaneous data rate offset between the transmitted datastream and the currently utilized HDSL communication link data rate, adjusting the HDSL communication data rate to move towards wander jitter low points or minimums for data rate offsets at a given HDSL data rate for the implementation. In one embodiment of the present invention, the number of long frames are counted to determine the present data rate offset at a CO HDSL communication device and the HDSL data/frame rate is selectively adjusted to an optimum data rate to place the present data rate offset as close as possible to experimentally determined wander “lows” or minimization spots of the HDSL chipset being utilized at given HDSL data/frame rates. In another embodiment of the present invention an embedded operation channel (EOC) is utilized to request the CPE/RMT HDSL communication device to determine the present data rate offset and communicate it to the CO HDSL communication device where the HDSL data/frame rate is adjusted, if necessary, to avoid experimentally determined wander maximums by moving the data rate offset closer towards experimentally determined wander jitter minimization spots of the HDSL chipset being utilized. In another embodiment of the present invention an HDSL communication device is characterized for wander jitter by sweeping the allowed transmitted datastream data rate for each possible HDSL data rate and recording the amount of wander jitter for each instantaneous data rate offset.

Every individual class of HDSL communication device design and/or HDSL chipset has a characteristic wander jitter response for that class. This wander jitter response is different in each class of device or chipset for each input data rate and HDSL data rate. To reduce wander jitter HDSL device and chipset embodiments of the present invention are profiled for each class of HDSL communication device and/or HDSL chipset that include an embodiment of the present invention in their design.

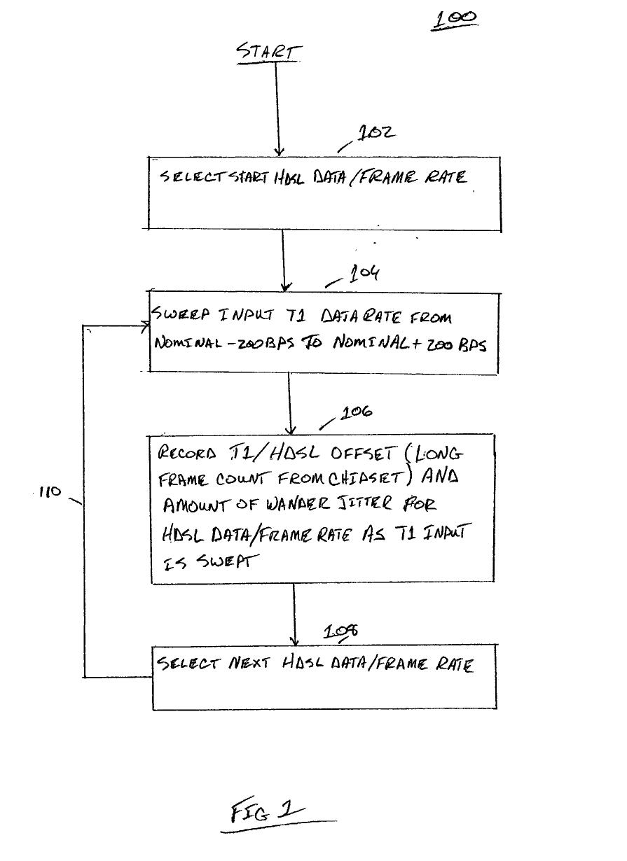

FIG. 1 is a simplified flowchart of an HDSL communication system wander performance detection algorithm for determining the wander jitter minimums of an HDSL communication device according to another embodiment of the present invention. In FIG. 1, the HDSL communication device or HDSL chipset to be characterized is coupled to an HDSL protocol communication link and an initial HDSL data rate is selected 102. The selection criteria for the initial and all subsequent HDSL data rates can include, but is not limited to, lowest data rate to highest, highest data rate to lowest, or random, so long as all data rates at the desired separation intervals are profiled for wander jitter. A test datastream pattern is transmitted through the HDSL protocol communication link. The transmitted test datastream data rate is swept 104, much as the HDSL data rate is, from its minimum allowed data rate to its maximum allowed data rate. In the algorithm of FIG. 1, a T1 datastream is swept from nominal −200 bps to nominal +200 bps. The amount of wander jitter and minimum wander jitter points for an instantaneous data rate of the transmitted datastream or instantaneous data rate offset are recorded 106 for the selected HDSL data rate as the input datastream is swept. The next HDSL data rate is selected 108 and the wander performance detection algorithm loops 110 to sweep 104 and record 106 the next selected HDSL data rate, continuing in this manner until all HDSL data rates have been swept and profiled for wander jitter. It is noted that other manners of characterizing the wander jitter profile of HDSL communication devices and HDSL chipsets according to teachings of the present invention are possible and will be apparent to those skilled in the art with the benefit of the present disclosure.

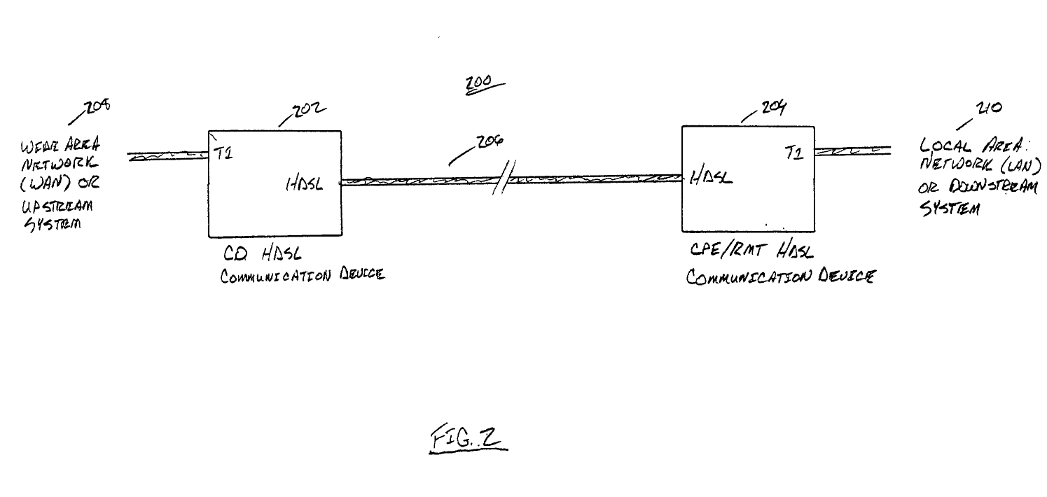

FIG. 2 is a simplified diagram of an HDSL communication system 200 according to one embodiment of the present invention. In FIG. 2, the HDSL communication system 200 contains two HDSL communication devices 202, 204 that are coupled through an HDSL communication link 206 which can be considered either a two or four wire HDSL communication link 206 for the purposes of the present disclosure. The central office (CO) HDSL communication device 202 encapsulates and transmits a datastream containing user data from an upstream system or WAN 210 through the HDSL communication link 206 to the CPE or RMT HDSL communication device 204 and local network or downstream system 212. The RMT HDSL communications device 204 in turn transmits user data between the local network or downstream system 212 through the HDSL communication link 206 to the CO HDSL communication device 202 and upstream system or WAN 210. The communication protocols and/or datastreams that can be transmitted through the HDSL communication link include, but are not limited to T1, Ethernet, E1, or ISDN. The systems that could comprise the local network or system 212 and upstream system or WAN 210 include, but are not limited to, a standalone device, a phone system, a computer network, or computer.

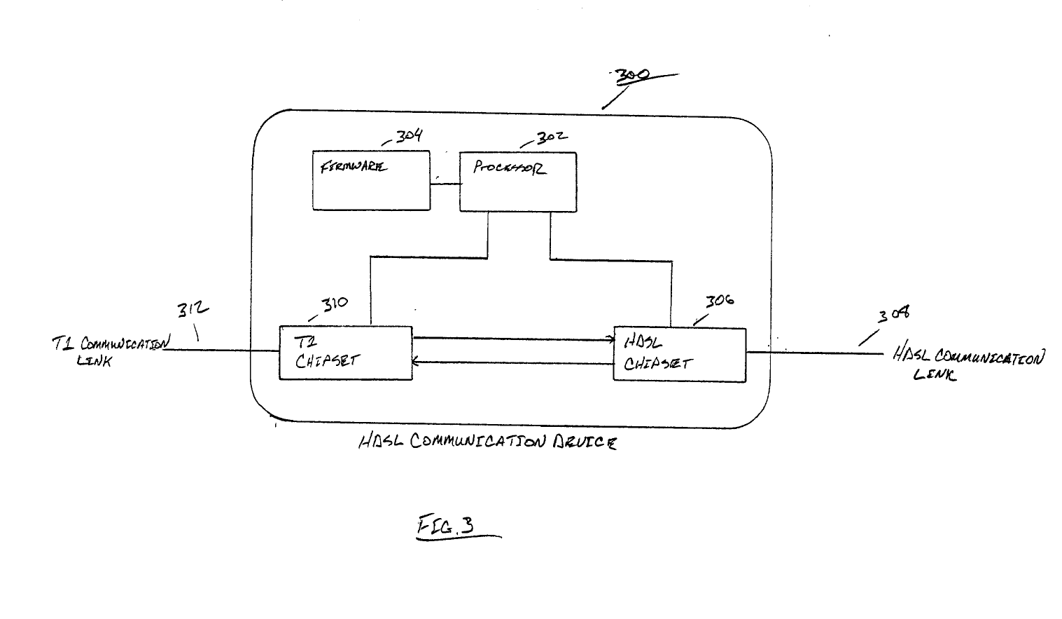

FIG. 3 is a simplified diagram of an HDSL communication device 300 according to one embodiment of the present invention. The HDSL communication device 300 of FIG. 3 can be considered either a CO HDSL communication device or a customer premise equipment CPE or RMT HDSL communication device with either a two or four wire HDSL communication link 302 for the purposes of the present disclosure. The HDSL communication device 300 has an HDSL interface 308 that is coupled to an HDSL communication link that utilizes HDSL communication signaling protocol. In one embodiment, HDSL communication device 300 includes a T1 or E1 interface 312 that can be coupled to either a WAN (if a CO device) or a local network (if a CPE device) with a T-carrier T1 or E1 link that utilizes American National Standards Institute (ANSI) T1.107 standard digital signal 1 (DS1) signaling. HDSL communication device 300 internally contains a processor 302, T1/E1 interface circuit or chipset 310, HDSL interface circuit or chipset 306, and non-volatile machine usable firmware storage media 304, such as a Flash memory or the like. The HDSL interface circuit 306 is coupled to the HDSL interface 308 and the T1/E1 interface circuit 310 is coupled to the T1 interface 312 of the HDSL communication device 300.

HDSL communication device software routines that initialize and operate an HDSL communication device are collectively referred to as firmware or ROM after the non-volatile read only memory (ROM) machine usable storage device that such routines have historically been stored in. It is noted that such firmware or ROM routines are stored on a variety of machine usable storage mediums that include, but are not limited to, a non-volatile Flash memory, a read only memory (ROM), an electrically erasable programmable read only memory (EEPROM), a one time programmable (OTP) device, a complex programmable logic device (CPLD), an application specific integrated circuit (ASIC), a magnetic media disk, etc. It is also noted that HDSL communication devices can take multiple other physical forms, including, but not limited to, HDSL communication devices that are functions of other systems, or network elements that have the HDSL communication device functionality expressed in firmware or even hard-coded in a device such as an application-specific integrated circuit (ASIC) chip.

Internally, HDSL interface circuit 306 is coupled to T1/E1 interface circuit 310 to pass data bi-directionally through the HDSL communication device 300 between the T1/E1 interface 312 to the HDSL interface 308. The processor 302 is coupled to T1/E1 interface circuit 310 and the HDSL interface circuit 306 and controls and communicates with them. The processor 302 is also coupled to the firmware storage media 304, which contains software routines or firmware required to initialize, configure, and operate the HDSL communication device 300. Storage media 312 also contains any software routines and data that are utilized to sense and correct wander jitter in the datastream being transmitted through the HDSL communication device 300. It is noted that other communication interfaces, dataports, communication busses, and/or other proprietary communication interface or protocol can also be included in various embodiments of the HDSL communication device 300 of FIG. 3, increasing communication options and configurations.

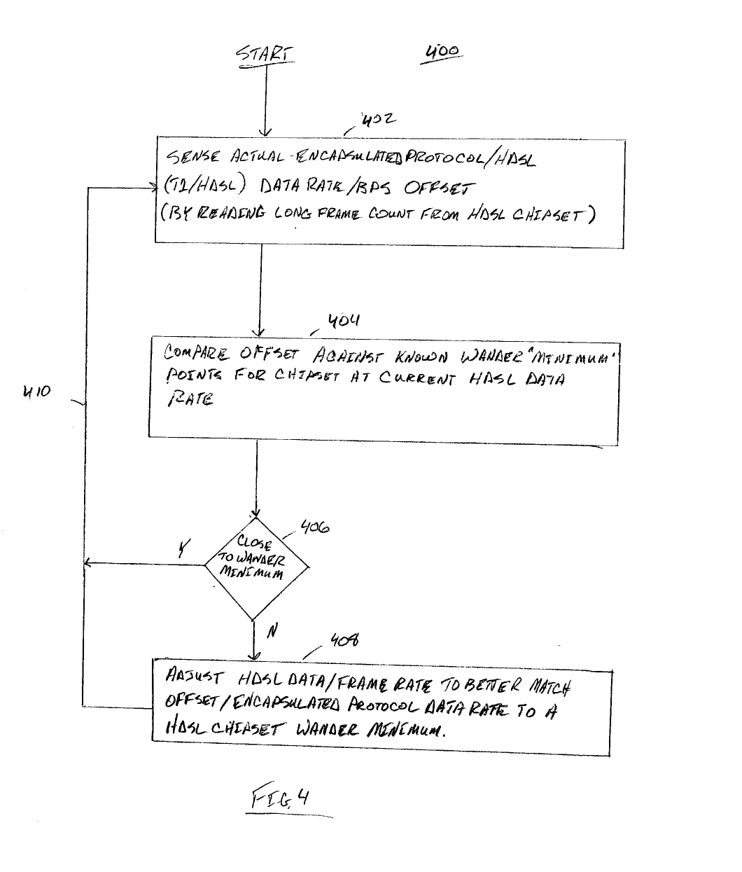

FIG. 4 is a simplified flowchart of one embodiment of a CO HDSL communication device with wander jitter reduction algorithm 400 according to an embodiment of the present invention. In the wander jitter reduction algorithm 400 of FIG. 4, the HDSL communication device transmitting a datastream across an HDSL protocol communication link senses 402 the actual/instantaneous data rate offset between the transmitted datastream and the selected HDSL datastream data rate being utilized. In one embodiment of the present invention the offset is measured by the HDSL chipset counting the number of long or short frames over a given time period. In another embodiment of the present invention the offset is measured by sensing the transmitted datastream data rate and the current HDSL datastream data rate and comparing them. It is noted that other methods of sensing or monitoring the transmitted datastream data rate, HDSL datastream data rate, and data rate offset are possible and should be apparent to those skilled in the art with the benefit of the present disclosure.

The measured data rate offset is then compared 404 against the predetermined low/minimum wander data rate offset values of the CO HDSL communication device for the selected HDSL data rate. In one embodiment of the present invention the predetermined low/minimum wander data rate offset values are kept in a firmware storage device of the HDSL communication device and is compared with the measured data rate offset by a processor. If the measured data rate offset is on or near a known wander minimum 406 the HDSL data rate of the CO HDSL communication device is not adjusted and the wander jitter reduction algorithm then returns 410 and loops again. If the measured data rate offset is not on or near a wander minimum value 406 the HDSL data rate of the CO HDSL communication device is adjusted 408 to an optimal data rate to move the instantaneous data rate offset at HDSL data rate to be as close as possible to a selected known wander jitter minimum. An optimal data rate is defined as a sending data rate or sending data rates of those available to the CO HDSL communication device that exhibit a minimal wander jitter or is below a selected low wander jitter threshold for minimums at the transmitted data rate. In one embodiment of the present invention, an optimal data rate that is proximate to the current HDSL datastream data rate is chosen. In another embodiment of the present invention, a HDSL datastream data rate that exhibits a minimal wander jitter is selected. In an additional embodiment of the present invention, the HDSL data rate is adjusted 406 by 10 Hz (in 1 Hz steps to preclude issues that can be caused by sudden HDSL data rate jumps) to an available optimal data rate to better match to a wander jitter minimum. The wander jitter reduction algorithm 400 then returns 410. The wander jitter reduction algorithm 400 continually loops in this manner to sense, compare, and adjust to promote instantaneous data rate offsets that are close to wander jitter minimums.

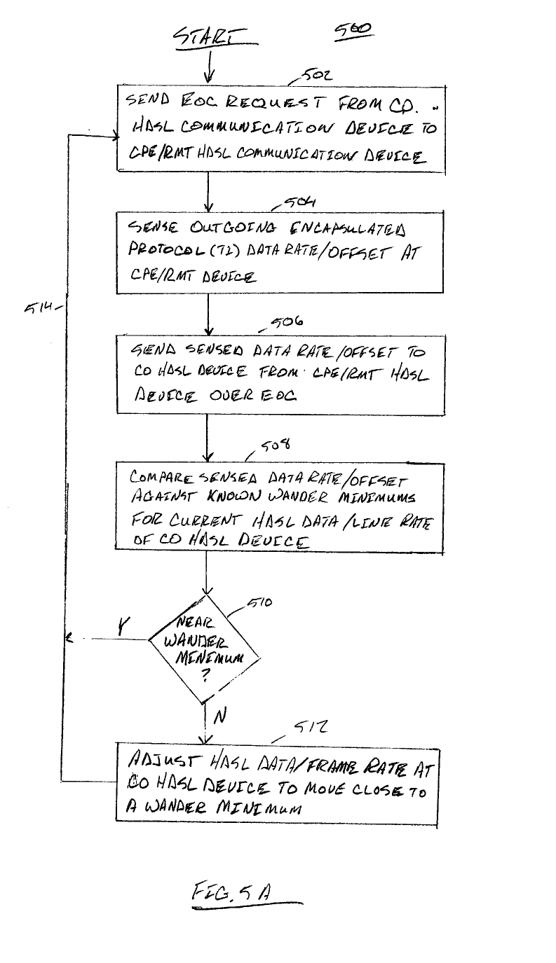

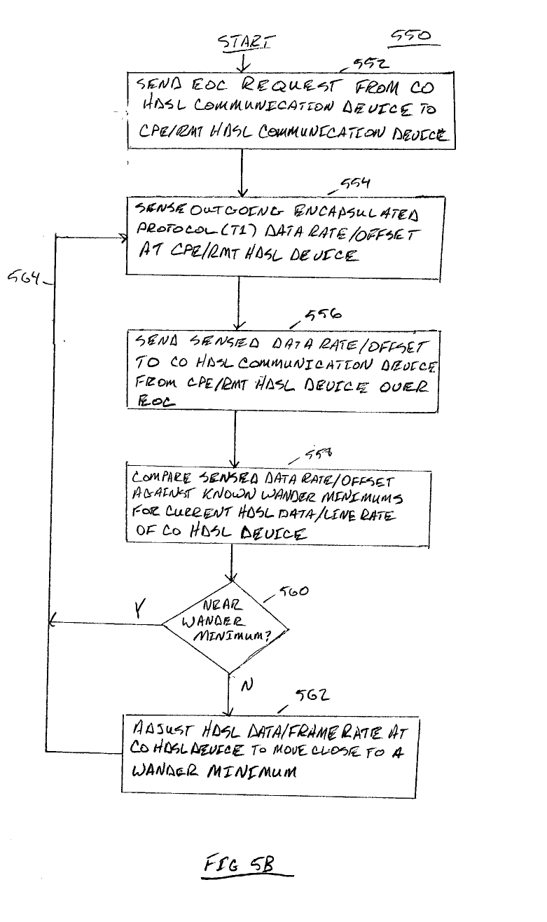

FIG. 5A is a simplified flowchart of one embodiment of an HDSL communication system wander reduction algorithm utilizing the embedded operation channel (EOC) according to another embodiment of the present invention. The EOC is incorporated in the data packet or frame of the HDSL transfer protocol to allow limited bandwidth for inter-device communication with a defined set of system operation commands. Unfortunately HDSL protocol does not define a set of EOC signals or packets for wander jitter operations. A non-standard set of EOC signals or packets must therefore be utilized for implementation of the wander jitter reduction algorithm, requiring that both the CO HDSL communication device and the RMT HDSL communication device understand these non-standard EOC signals or packets. In the wander jitter reduction algorithm 500 of FIG. 5A, a CO HDSL communication device, such as that of FIG. 3, transmits a datastream across an HDSL protocol communication link and sends 502 an EOC request across the HDSL protocol communication link to the RMT HDSL communication device to initiate wander jitter sensing. The RMT HDSL communication device, upon receiving the EOC request, senses 504 either the actual/instantaneous data rate of the transmitted datastream or the actual/instantaneous data rate offset between the transmitted datastream and the selected HDSL datastream data rate being utilized, herein referred to as the data rate. The RMT HDSL communication device then sends 506 the sensed data rate back to the CO HDSL communication device over the EOC channel. At the CO HDSL communication device the measured data rate received over the EOC channel from the RMT HDSL communication device is then compared 508 against the predetermined low/minimum wander data rate values of the CO HDSL communication device for the HDSL data rate being utilized. If the measured data rate offset is on or near a known wander minimum 510 the HDSL data rate of the CO HDSL communication device is not adjusted and the wander jitter reduction algorithm then returns 514 and waits for another EOC request to be sent 502 from the CO HDSL communication device. If the measured data rate offset is not on or near a wander minimum value 510 the HDSL data rate of the CO HDSL communication device is adjusted 512 to move the instantaneous data rate offset at HDSL data rate to an optimum data rate to be as close as possible to a selected known wander jitter minimum. In one embodiment of the present invention, the HDSL data rate is adjusted 512 by 10 Hz (in 1 Hz steps to preclude issues that can be caused by sudden HDSL data rate jumps) to better match to a wander jitter minimum. The wander jitter reduction algorithm 500 then returns 514 and waits for another EOC request to be sent 502 from the CO HDSL communication device. The wander jitter reduction algorithm 500 continually loops in this manner to sense, compare, and adjust to promote instantaneous data rate offsets that are close to wander jitter minimums.

FIG. 5B is a simplified flowchart of one embodiment of an HDSL communication system wander reduction algorithm utilizing the EOC channel according to another embodiment of the present invention. In the wander jitter reduction algorithm 550 of FIG. 5B, a CO HDSL communication device, such as that of FIG. 3, transmits a datastream across an HDSL protocol communication link and sends 552 an EOC request across the HDSL protocol communication link to the RMT HDSL communication device to initiate continuous wander jitter sensing without further EOC requests. The RMT HDSL communication device, upon receiving the initiate EOC request, places itself into a continuous reporting mode and senses 554 the actual/instantaneous data rate of the transmitted datastream. The RMT HDSL communication device then sends 556 the sensed data rate back to the CO HDSL communication device over the EOC channel. At the CO HDSL communication device the measured data rate received over the EOC channel from the RMT HDSL communication device is then compared 558 against the predetermined low/minimum wander data rate values of the CO HDSL communication device for the HDSL data rate being utilized. If the measured data rate offset is on or near a known wander minimum 560 the HDSL data rate of the CO HDSL communication device is not adjusted and the wander jitter reduction algorithm then returns 564 and senses 554 the data rate again, not waiting for another EOC request to be sent 552 from the CO HDSL communication device. If the measured data rate offset is not on or near a wander minimum value 560 the HDSL data rate of the CO HDSL communication device is adjusted 562 to move the instantaneous data rate offset at HDSL data rate to be as close as possible to a selected known wander jitter minimum. In one embodiment of the present invention, the HDSL data rate is adjusted 562 by 10 Hz (in 1 Hz steps to preclude issues that can be caused by sudden HDSL data rate jumps) to an optimum data rate to better match to a wander jitter minimum. The wander jitter reduction algorithm 550 then returns 564 and senses 554 the data rate again, not waiting for another EOC request to be sent 552 from the CO HDSL communication device. The RMT HDSL communication device of the wander jitter reduction algorithm 550 continually loops in this manner to allow the HDSL communication system to sense, compare, and adjust to promote instantaneous data rate offsets that are close to wander jitter minimums.

It is noted that the wander reduction algorithms of FIGS. 5A and 5B are particularly advantageous when the CO HDSL communication device cannot sense the data rate offset directly itself because of design or implementation issues.

Alternative HDSL communication device embodiments of the present invention with an improved wander jitter reduction circuit and method will be apparent to those skilled in the art with the benefit of the present disclosure, and are also within the scope of the present invention.

### CONCLUSION

An apparatus and method have been described that allows for improved wander jitter reduction in communication devices and associated communication links, in particular on HDSL communication devices and links. The improved device apparatus and method detects the current data rate offset of the HDSL data rate being utilized and the data rate of the datastream being transmitted through the HDSL communication link and allows for the transmitting HDSL communication device to adjust the HDSL data rate to promote instantaneous data rate offsets that are close to wander jitter minimum points. The improved device apparatus and method also allows for the characterization of communication devices for their specific wander jitter low activity points by sweeping the input data rate being transmitted at differing HDSL data rates.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of operating a High-speed Digital Subscriber Line (HDSL) communication device, comprising:
sensing an offset between a data rate of a datastream and a selected HDSL datastream data rate; and
selectively adjusting the HDSL datastream data rate to an optimal data rate to move the data rate offset closer to a low wander jitter minimum.

2. The method of claim 1, wherein sensing an offset between a data rate of a datastream and a selected HDSL datastream data rate further comprises sensing the data rate of the datastream at the HDSL communication device.

3. The method of claim 1, wherein sensing an offset between a data rate of a datastream and a selected HDSL datastream data rate further comprises sensing the data rate of the datastream remotely at a remote (RMT) HDSL communication device.

4. The method of claim 1, wherein the High-speed Digital Subscriber Line (HDSL) communication device is a central office (CO) HDSL communication device.

5. The method of claim 1, wherein the High-speed Digital Subscriber Line (HDSL) communication device is one of an HDSL2 communication device and HDSL4 communication device.

6. The method of claim 1, wherein selectively adjusting the HDSL datastream data rate to an optimal data rate to move the data rate offset closer to a low wander jitter minimum further comprises selectively adjusting the HDSL datastream data rate in 10 Hz steps.

7. The method of claim 6, wherein selectively adjusting the HDSL datastream data rate in 10 Hz steps further comprises selectively adjusting the HDSL datastream data rate in 10 Hz steps by 1 Hz increments.

8. The method of claim 1, wherein sensing an offset between a data rate of a datastream and a selected HDSL datastream data rate further comprises sensing an offset between a data rate of a datastream and a selected HDSL datastream data rate by counting the number of long frames in a selected time period.

9. The method of claim 1, wherein sensing an offset between a data rate of a datastream and a selected HDSL datastream data rate further comprises sensing an offset between a data rate of a datastream and a selected HDSL datastream data rate by counting the number of short frames in a selected time period.

10. The method of claim 1, wherein sensing an offset between a data rate of a datastream and a selected HDSL datastream data rate further comprises sensing a data rate of a datastream and a selected HDSL datastream data rate.

11. The method of claim 1, wherein the datastream is one of a T1 and an E1 datastream.

12. The method of claim 1, further comprising:
receiving a datastream; and
transmitting the data of the datastream in an HDSL datastream datastream.

13. The method of claim 1, further comprising:
characterizing the HDSL communication device for wander jitter minimums by selecting a range of HDSL data rates, sweeping a datastream data rate range for each HDSL data rate, and recording a wander jitter profile for the HDSL communication device.

14. A method of operating a High-speed Digital Subscriber Line (HDSL) communication system, comprising:
sensing an offset between a data rate of a transmitted datastream and the data rate of an HDSL protocol datastream of an HDSL communication link; and
selectively adjusting the HDSL protocol datastream data rate to an optimal data rate to move the data rate offset closer to a low wander jitter minimum.

15. The method of claim 14, wherein sensing an offset between a data rate of a transmitted datastream and the data rate of an HDSL protocol datastream of an HDSL communication link further comprises sensing the data rate of the transmitted datastream on a central office (CO) HDSL communication device.

16. The method of claim 14, wherein sensing an offset between a data rate of a transmitted datastream and the data rate of an HDSL protocol datastream of an HDSL communication link further comprises sensing the data rate of the transmitted datastream on a remote (RMT) HDSL communication device utilizing an embedded operations channel (EOC) signal of the HDSL protocol datastream.

17. The method of claim 14, wherein the High-speed Digital Subscriber Line (HDSL) communication system is one of an HDSL2 communication system and an HDSL4 communication system.

18. The method of claim 14, wherein selectively adjusting the HDSL protocol datastream data rate to an optimal data rate to move the data rate offset closer to a low wander jitter minimum further comprises selectively adjusting the HDSL protocol datastream data rate in 10 Hz steps.

19. The method of claim 18, wherein selectively adjusting the HDSL protocol datastream data rate in 10 Hz steps further comprises selectively adjusting the HDSL protocol datastream data rate in 10 Hz steps by 1 Hz increments.

20. The method of claim 14, wherein sensing an offset between a data rate of a transmitted datastream and the data rate of an HDSL protocol datastream of an HDSL communication link further comprises sensing an offset between a data rate of a transmitted datastream and an HDSL protocol datastream data rate by counting the number of long frames in a selected time period.

21. The method of claim 14, wherein sensing an offset between a data rate of a transmitted datastream and the data rate of an HDSL protocol datastream of an HDSL communication link further comprises sensing an offset between a data rate of a transmitted datastream and an HDSL protocol datastream data rate by counting the number of short frames in a selected time period.

22. The method of claim 14, wherein sensing an offset between a data rate of a transmitted datastream and the data rate of an HDSL protocol datastream of an HDSL communication link further comprises sensing a data rate of a transmitted datastream and an HDSL protocol data rate.

23. The method of claim 14, wherein the transmitted datastream is one of a T1 and an E1 datastream.

24. The method of claim 14, further comprising:
receiving a datastream; and
transmitting the data of the datastream across the HDSL communication link.

25. A method of operating a High-speed Digital Subscriber Line (HDSL) communication device, comprising:
receiving a T1 datastream;
incorporating the T1 datastream in an HDSL protocol datastream;
transmitting the HDSL protocol datastream;
sensing an offset between an instantaneous data rate of the T1 datastream and a data rate of the HDSL protocol datastream; and
selectively adjusting the HDSL protocol datastream data rate to an optimal data rate to move the data rate offset closer to a wander jitter minimum point.

26. The method of claim 25, further comprising:
storing a wander jitter profile on a machine readable storage medium.

27. The method of claim 25, wherein the High-speed Digital Subscriber Line (HDSL) communication device is one of an HDSL2 communication device and an HDSL4 communication device.

28. The method of claim 25, wherein selectively adjusting the HDSL protocol datastream data rate to an optimal data rate to move the data rate offset closer to a wander jitter minimum point further comprises selectively adjusting the HDSL protocol datastream data rate in 10 Hz steps.

29. The method of claim 28, wherein selectively adjusting the HDSL protocol datastream data rate in 10 Hz steps further comprises selectively adjusting the HDSL protocol datastream data rate in 10 Hz steps by 1 Hz increments.

30. The method of claim 25, wherein sensing an offset between an instantaneous data rate of the T1 datastream and a data rate of the HDSL protocol datastream further comprises sensing an offset between an instantaneous data rate of the T1 datastream and a data rate of the HDSL protocol datastream by counting the number of long frames in a selected time period.

31. The method of claim 25, further comprising:
characterizing the HDSL communication device for wander jitter by selecting a range of HDSL data rates, sweeping a datastream data rate range for each HDSL data rate, and recording a profile of wander jitter minimums for the HDSL communication device.

32. A machine-usable medium having machine-readable instructions stored thereon for execution by a processor of a communication device to perform a method comprising:
receiving a T1 datastream;
incorporating the T1 datastream in an HDSL protocol datastream;
transmitting the HDSL protocol datastream;
sensing an offset between an instantaneous data rate of the T1 datastream and a data rate of the HDSL protocol datastream; and
selectively adjusting the HDSL protocol datastream data rate to an optimal data rate to reposition the data rate offset closer to a wander jitter minimum.

33. The machine-usable medium of claim 32, wherein the High-speed Digital Subscriber Line (HDSL) communication device is one of an HDSL2 communication device and an HDSL4 communication device.

34. The machine-usable medium of claim 32, wherein selectively adjusting the HDSL protocol datastream data rate to an optimal data rate to reposition the data rate offset closer to a wander jitter minimum further comprises selectively adjusting the HDSL protocol datastream data rate in 10 Hz steps.

35. The machine-usable medium of claim 32, further comprising:
characterizing the HDSL communication device for wander jitter by selecting a range of HDSL data rates, sweeping a datastream data rate range for each HDSL data rate, and recording a wander jitter profile of low wander jitter minimums for the HDSL communication device.

36. A high-speed digital subscriber line (HDSL) communication device, comprising:
an HDSL interface coupled to an HDSL chipset, wherein the HDSL chipset is adapted to transceive an HDSL datastream with a selectively adjustable HDSL data rate through the HDSL interface;
a data interface coupled to the HDSL chipset, wherein the data interface is adapted to transceive a datastream with a data rate; and
wherein a data rate offset is measured between the datastream data rate and the HDSL data rate by the HDSL chipset and the HDSL data rate is selectively adjusted to an optimal data rate to move the data rate offset closer to a low wander jitter minimum.

37. The high-speed digital subscriber line (HDSL) communication device of claim 36, wherein a wander jitter reduction firmware routine is stored on a machine readable storage medium for execution on a processor coupled to the HDSL chipset.

38. The high-speed digital subscriber line (HDSL) communication device of claim 36, wherein a wander jitter profile of the HDSL communication device is stored on a machine readable storage medium.

39. The high-speed digital subscriber line (HDSL) communication device of claim 36, wherein the High-speed Digital Subscriber Line (HDSL) communication device is a central office (CO) HDSL communication device.

40. The high-speed digital subscriber line (HDSL) communication device of claim 36, wherein the High-speed Digital Subscriber Line (HDSL) communication device is an HDSL2 communication device.

41. The high-speed digital subscriber line (HDSL) communication device of claim 36, wherein the High-speed Digital Subscriber Line (HDSL) communication device is an HDSL4 communication device.

42. The high-speed digital subscriber line (HDSL) communication device of claim 36, wherein the HDSL data rate is selectively adjusted in 10 Hz steps.

43. The high-speed digital subscriber line (HDSL) communication device of claim 42, wherein the HDSL data rate is selectively adjusted in 10 Hz steps by 1 Hz increments.

44. The high-speed digital subscriber line (HDSL) communication device of claim 36, wherein the data rate offset is measured by counting the number of long frames in a selected time period.

45. The high-speed digital subscriber line (HDSL) communication device of claim 36, wherein the data rate offset is measured by counting the number of short frames in a selected time period.

46. The high-speed digital subscriber line (HDSL) communication device of claim 36, wherein the data interface is one of a T1 and an E1 interface.

47. A high-speed digital subscriber line (HDSL) communication system, comprising:
an HDSL communication link; and
a plurality of HDSL communication devices coupled to the HDSL communication link, wherein a first HDSL communication device of the plurality of HDSL communication devices is a central office (CO) HDSL communication device and a second HDSL communication device of the plurality of HDSL communication devices is a remote (RMT) HDSL communication device, and wherein at least one of the plurality of HDSL communication devices comprises:
an HDSL interface coupled to an HDSL chipset, wherein the HDSL chipset is adapted to transceive an HDSL datastream with a selectively adjustable HDSL data rate through the HDSL interface to the HDSL communication link;
a data interface coupled to the HDSL chipset, wherein the data interface is adapted to transceive a datastream with a data rate;
wherein a data rate offset is measured between the datastream data rate and the HDSL data rate by the HDSL chipset; and
wherein the HDSL data rate is selectively adjusted to an optimal data rate to reposition the data rate offset closer to a wander jitter minimum.

48. The high-speed digital subscriber line (HDSL) communication system of claim 47, wherein a wander jitter profile of high wander jitter sweet spots of the HDSL communication device is stored on a machine readable storage medium.

49. The high-speed digital subscriber line (HDSL) communication system of claim 47, wherein the High-speed Digital Subscriber Line (HDSL) communication system is one of an HDSL2 communication system and an HDSl4 communication system.

50. The high-speed digital subscriber line (HDSL) communication system of claim 47, wherein the HDSL data rate is selectively adjusted in 10 Hz steps.

51. The high-speed digital subscriber line (HDSL) communication system of claim 50, wherein the HDSL data rate is selectively adjusted in 10 Hz steps by 1 Hz increments.

52. The high-speed digital subscriber line (HDSL) communication system of claim 47, wherein the data rate offset is measured by counting the number of long frames in a selected time period.

53. The high-speed digital subscriber line (HDSL) communication system of claim 47, wherein the data rate offset is measured by counting the number of short frames in a selected time period.

54. The high-speed digital subscriber line (HDSL) communication system of claim 47, wherein the data interface is one of a T1 and an E1 interface.

55. A method of characterizing a High-speed Digital Subscriber Line (HDSL) communication device, comprising:
selecting each HDSL data rate in turn of a plurality of HDSL data rates;
sweeping an allowed data rate range for an input datastream for each selected HDSL data rate; and
sensing and recording a wander jitter rate and wander jitter minimum points for the HDSL communication device for an instantaneous data rate of the input datastream at each selected HDSL data rate.

56. The method of characterizing a High-speed Digital Subscriber Line (HDSL) communication device of claim 55, wherein sensing and recording a wander jitter rate and wander jitter minimum points for the HDSL communication device for an instantaneous data rate of the input datastream at each selected HDSL data rate further comprises sensing and recording a wander jitter rate and wander jitter minimum points for the HDSL communication device for a data rate offset of an instantaneous data rate of the input datastream at each selected HDSL data rate.

57. The method of characterizing a High-speed Digital Subscriber Line (HDSL) communication device of claim 55, wherein selecting each HDSL data rate in turn of a plurality of HDSL data rates further comprises selecting a plurality of HDSL data rates that are 10 Hz apart.

58. A high-speed digital subscriber line (HDSL) communication system, comprising:
an HDSL communication link; and
a central office (CO) HDSL communication device coupled to the HDSL communication link and a remote (RMT) HDSL communication device coupled to the HDSL communication link, wherein the CO HDSL communication device comprises:
an HDSL interface coupled to an HDSL chipset, wherein the HDSL chipset is adapted to transceive an HDSL datastream with a selectively adjustable HDSL data rate through the HDSL interface to the HDSL communication link;
a T1 data interface coupled to the HDSL chipset, wherein the T1 data interface is adapted to transceive a T1 datastream with a data rate;
wherein a data rate offset is measured between the T1 datastream data rate and the HDSL data rate by the HDSL chipset; and
wherein the HDSL data rate is selectively adjusted to an optimal data rate to move the data rate offset closer to a low wander jitter minimum.

59. A method of wander reduction, comprising:
sensing an offset between a data rate of a datastream and a selected High-speed Digital Subscriber Line (HDSL) datastream data rate; and
selectively adjusting the HDSL datastream data rate to an optimal data rate to move the data rate offset closer to a low wander jitter minimum of an HDSL communication device.

60. The method of wander reduction of claim 59, wherein the HDSL communication device is a HDSL chipset.
